(19) United States
(12) Patent Application Publication
(10) Pub. No.: US 2015/0362138 A1
(43) Pub. Date: Dec. 17, 2015

(54) A PORTABLE LIGHT STRING

(71) Applicant: Ohad Ben Aharon, Mesilat-Tzion (IL)

(72) Inventor: Ohad Ben Aharon, Mesilat-Tzion (IL)

(21) Appl. No.: 14/128,702

(22) PCT Filed: Jun. 21, 2012
(86) PCT No.: PCT/IL2012/000247

§ 371 Date: Feb. 11, 2014

(30) Foreign Application Priority Data
Jun. 23, 2011 (IL) 213755

(51) Int. Cl. F21S 4/00; F21V 31/04; F21V 21/005; F21S 9/00

(52) U.S. Cl. CPC F21S 4/001; F21S 9/00; F21V 31/04; F21V 21/005; F21Y 2101/02

(57) ABSTRACT

The present invention relates to the a portable light string illuminating device, which comprises: a) a plurality of light bulbs interconnected by an electrically conductive string in such a way that when said conductive string is electrically connected to a power source said light bulbs are illuminated; b) a thin flexible insulating material for supporting said light bulbs, wherein said thin flexible insulating material is used as a flexible platform along which said light bulbs are attached from the inner surface of said thin flexible insulating material; and c) two handles located from both ends of said thin flexible insulating, for allowing to stretch said flexible insulating material 12, and thereby to maximally stretch said light string.

### FIELD OF THE INVENTION

The present invention relates to the field of light strings. More particularly, the invention relates to a portable light emitting strap assembly, which comprises a plurality of light emitting diode assemblies, to use as directional light outdoor at any condition.

### BACKGROUND OF THE INVENTION

Light-emitting diode (LED) lamp strings are commonly used today and various types of LED lamp string, which are operated with different types of power sources, including alternate current (AC) or direct current (DC), are available in the market. For all types of LED lamp string, they are powered by alternate current. The alternate current is received by the LED lamp string through plugging with an external power source and the alternate current can be directly supplied to the LED lamp string or it is fed through an electrical adaptor to be converted into direct current. To use an LED lamp string outdoors, a power cable connected to an indoor power source must be arranged. This makes it unsafe and inconvenient in switching between different sites. Further, it makes the use of the LED lamp string troublesome and impractical due to outdoors conditions such as winds.

It would be desirable to improve the effectiveness of using such light strings outdoors. Therefore, it is an object of the present invention to provide a portable light string/strap which is capable of being directed to a specific location.

It is another object of the present invention to provide a portable light string/strap that is suitable to resist to outdoor condition.

Other objects and advantages of the invention will become apparent as the description proceeds.

### SUMMARY OF THE INVENTION

The present invention relates to the a portable light string illuminating device, which comprises: a) a plurality of light bulbs interconnected by an electrically conductive string in such a way that when said conductive string is electrically connected to a power source said light bulbs are illuminated; b) a thin flexible insulating material for supporting said light bulbs, wherein said thin flexible insulating material is used as a flexible platform along which said light bulbs are attached from the inner surface of said thin flexible insulating material; and c) two handles located from both ends of said thin flexible insulating, for allowing to stretch said flexible insulating material 12, and thereby to maximally stretch said light string.

According to an embodiment of the present invention, the thin flexible insulating material further comprises one or more pockets distributed along the length of said thin flexible insulating material, for accommodating weights in order to limit the movements of said light string due to winds, and to better set the lighting direction to any desired direction.

According to an embodiment of the present invention, the power source is selected from the group consisting of: electric network, generators, a battery, one or more solar cells, rechargeable battery or any combination thereof.

According to an embodiment of the present invention, the plurality of light bulbs can be configured and distributed along the thin flexible insulating material in variety of ways quantity and sizes. The light bulbs can be any type of bulb such as, LED, neon, Infra Red and the like.

According to an embodiment of the present invention, the handles are attached to the thin flexible insulating material via any suitable attaching technique, such as stitching.

According to an embodiment of the present invention, the thin flexible insulating material is made of textile material. Optionally, at least the outer surface of the thin flexible insulating material can be made of a waterproof material. The portable light string may further comprise a sealing means for ensuring tight engagement between the light bulbs and the electrical connection to the power source.

According to an embodiment of the present invention, the handles are configured in such a way that each handle can be physically interconnected with a handle of additional portable light string device. According to an embodiment of the present invention, the conductive string further comprises an electrical conductive extension means for allowing to electrically connecting said portable light string to one or more additional portable light strings. This allows using a single power source to drive a plurality of interconnected portable light strings.

### BRIEF DESCRIPTION OF THE DRAWINGS

In the drawings:

FIG. 1 schematically illustrates a light string/strap, according to an embodiment of the present invention; and

FIG. 2 shows an example of a light string/strap operated by a battery, according to an embodiment of the present invention.

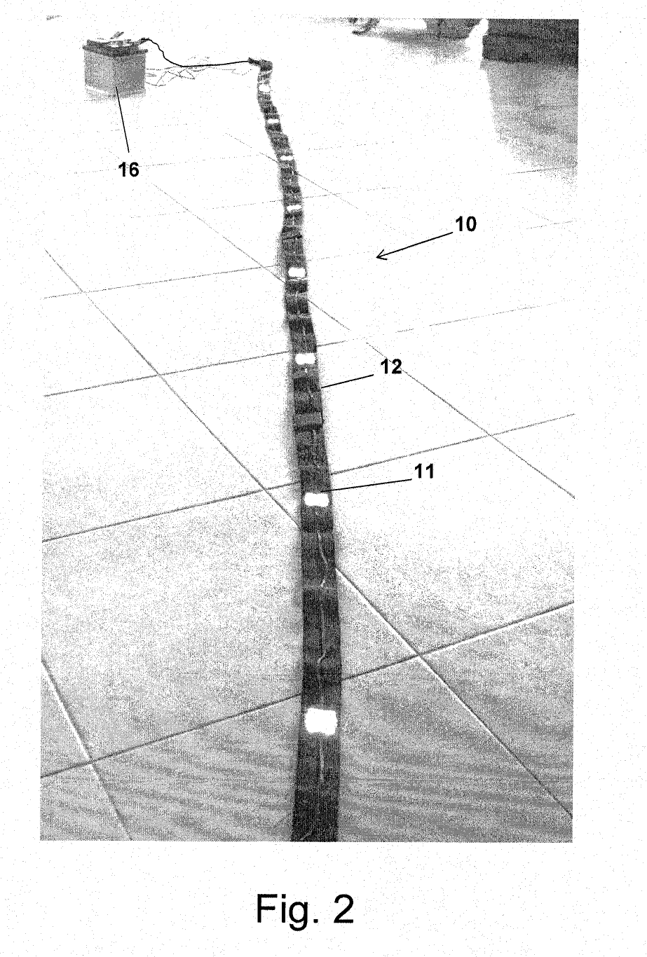

### DETAILED DESCRIPTION OF PREFERRED EMBODIMENTS

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

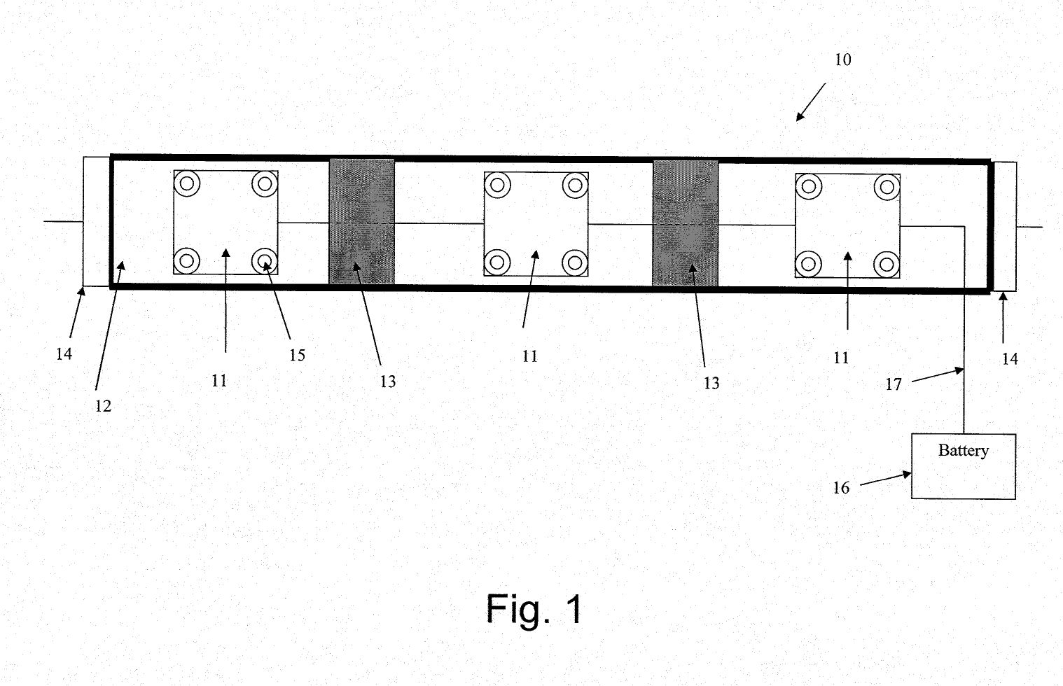

The present invention provides a light-emitting diode (LED) lamp string/strap device powered by a battery. Reference is now made to FIG. 1 for illustration of the present invention. FIG. 1 illustrates the features of this invention which distinguish over conventional practices. It is to be understood that the description of the embodiment shown in FIG. 1 is intended for illustrative purposes and is not intended to be limiting.

FIG. 1 schematically illustrates a light string 10 in accordance with one practice of the present invention. Light string 10 comprises a plurality of light bulbs 15 interconnected by an electrically conductive string 17 and a thin flexible insulating material 12 for supporting the light bulbs 15. When the conductive string 17 is electrically connected to a battery 16 (i.e., to a power source) the light bulbs 15 are illuminated as is known in the art. The plurality of light bulbs 15 can be configured and distributed in variety of ways (including their quantity and sizes), the arrangement of the light bulbs 15, may be series, parallel or other combination thereof, for example, the light string 10 may comprises two or more serially connected lighting units 11, wherein each lighting unit 11 consists of four light bulbs 15 arranged in a square-like form (as shown with respect to FIG. 1). Of course, the light bulbs 15 can be arranged in any desired geometrical form or shapes, such as square, cross, circle, etc.

The thin flexible insulating material 12 may have an elongated form (e.g., rectangular) or any other geometrical form (e.g., square, cross, etc.) that will allow the layout of the light bulbs 15 along it. The flexible insulating material 12 is used as a flexible platform (or a strap like platform) along which the light bulbs 15 are attached (e.g., on the inner surface of the thin flexible insulating material 12). The thin flexible insulating material 12 comprises two handles 14 located from both ends of the thin flexible material 12. Handles 14 allow to stretch the flexible insulating material 12, and hang it (in the air) between two distanced objects and thereby to maximally stretch the light string 10. As the light string 10 is configured also for outdoor use, the stretching of light string 10 is essential, in particular, in case of winds. The stretching of light string 10 reduces its movements and it allows aiming the lights emitted from the light bulbs 15 to a desired direction. For example, the handles 14 can be heavy duty handles made from rigid material, such as metal.

Handle 14 can be attached to thin flexible insulating material 12 via any suitable attaching technique, such as stitching. For example, handles 14 may have an oval or rectangular ring like shape, wherein about half of the ring like shape of each handle 14 is being wrapped by the end portion of the thin flexible insulating material 12, in such a way that handle is being threaded on the end portion. Now folding and stitching the folded part of the end portion over the handle 14, secures the handle 14 to the thin flexible insulating material 12, as known to a person skilled in the art.

According to an embodiment of the present invention, the handles 14 can be configured in such a way that each handle 14 can be physically interconnected with a handle of an additional portable light string device.

According to an embodiment of the present invention, the conductive string further comprises an electrical conductive extension means for allowing to electrically connect the portable light string to one or more additional portable light strings. This allows using a single power source to drive a plurality of interconnected portable light strings. For example, the electrical conductive extension means can be an extended conductive wire with set of interconnected and conductive plugs as well known in the art. Alternatively, each handle 14 may further comprise electrical contacts which are electrically connected to the electrically conductive string 17, thereby allowing to electrically connecting the portable light string 10 and each interconnected additional light string to the same power source (i.e., using a plurality of interconnected light strings 10 with a single power source).

For example, the handles 14 can be configured in a buckle like form those the distal handle will have a male part and the proximal handle will have a mating female part. The male part (or the female part) may include resistant features to prevent disengagement operation while stretching the light string. The resistant features may include webbing in the form of flanges or struts, or barbs or prongs that increase the difficulty for disengaging the buckle (i.e., the male part from the female part).

According to an embodiment of the present invention, the thin flexible insulating material 12 further comprises one or more pockets 13 distributed along its length (e.g., between two adjacent light units 11 as shown with respect to FIG. 1, or in other orders as required). Pockets 13 are used to accommodate weights (not shown) in order to further prevent the movements of light string 10 due to winds, and to better set (i.e., aimed) the lighting direction emitted from light bulb 15 to any desired direction.

The thin flexible insulating material 12 and lighting units 11 are secured together in any suitable manner that is known in the art (e.g., adhesion, stitching, etc).

According to an embodiment of the present invention, light string 10 further comprises a sealing means (not shown) that ensures tight engagement between the light bulbs 15 and the electrical connection to battery 16. Furthermore, at least the outer surface of the thin flexible insulating material 12 can be made of a waterproof material. Thus, outdoor use of the light string 10 is protected against poor weather and rains. For example, light string 10 may further comprise a light transmitting portion (not shown) of any known shape which is suitable to cover the light bulbs. The light transmitting portion can be made of a transparent or translucent material so that when light bulbs 15 are illuminated the light may readily pass through that light transmitting portion. If desired, the light transmitting portion could be made of a colored material, as known in the art.

It is to be understood that although the invention has been described in terms of incorporating LED bulbs in a light string, the invention could be practiced with an individual LED bulb used for any purpose such as in industry or home use. Where used for such other purposes a single LED bulb could be used such as for a street light. Alternatively, a series of individual LED bulbs could be used such as for ceiling lighting where the bulbs are totally separate and distinct from each other, or where the bulbs might even be mounted in a string fashion, although not intended necessarily to be used as a decorative light string. Optionally, the light string 10 can be attached to any type of ceiling or wall either for indoor or outdoor usage.

The thin flexible insulating material 12 can be made of any suitable known flexible material and is preferably made of a heavy duty textile material or fabric such as cotton, jute, etc, as the light string 10 is directed to be used as an outdoor lighting unit which should resists extreme weather conditions. The invention, however, can be practiced with materials other than textile material, including acrylic or other plastics.

Light string 10 could be made of any suitable size and shape. In an embodiment such as illustrated in FIG. 1, for example, the thin flexible insulating material 12 could have a length of 0.5 meter up to lengths of several meters or more. The light string 10 may include any suitable number and/or types/sizes of light bulbs 15 or light units 11, such as 8 light units 11 spaced about 30 cm apart. The light string 10 could have any suitable length and width, such as being 1 meter or even 100 meter long. Light string 10 could be designed to operate with any type of power source, such as 12/24 volt battery, either directly or via the common lighter socket of a vehicle, electricity network (110/220 volts), etc. It is to be understood that the dimensions in the above specific example are merely intended to be illustrative of one practice of the invention.

According to some embodiments of the present invention, the may include a two-line and two-circuit lamp string of a single double-color LED bulb, which only adopts two power transmission lines. In a series circuit, according to different voltage and different numbers of single double-color LED bulbs, resistors with different resistance tolerance are arranged. The single double-color LED bulb adopts two LED with different polarities and different colors which are connected in parallel and inwards arranged in one bulb. Thus, on the same neon lamp, the utility model can display different color combination, can realize the light emission of the LED with different colors on the same light emitting body under the control of a special two-line and two-circuit controller, has the advantages of convenient machining and beautiful and neat external appearance, and reaches decorative effects. The neon lamp can be suitable for outdoor use, and has the advantages of high durability and long service life. The light bulb can also be an infra red bulb.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A portable light string illuminating device comprising:
a. a plurality of light bulbs interconnected by an electrically conductive string in such a way that when said conductive string is electrically connected to a power source said light bulbs are illuminated;
b. a thin flexible insulating material for supporting said light bulbs, wherein said thin flexible insulating material is used as a flexible platform along which said light bulbs are attached from the inner surface of said thin flexible insulating material; and
c. two handles located from both ends of said thin flexible insulating, for allowing to stretch said flexible insulating material 12, and thereby to maximally stretch said light string.

2. A portable light string according to claim 1, in which the thin flexible insulating material further comprises one or more pockets distributed along the length of said thin flexible insulating material, for accommodating weights in order to limit the movements of said light string due to winds, and to better set the lighting direction to any desired direction.

3. A portable light string according to claim 1, in which the power source is selected from the group consisting of: electric network, generators, a battery, one or more solar cells, rechargeable battery or any combination thereof.

4. A portable light string according to claim 1, in which the plurality of light bulbs can be configured and distributed along the thin flexible insulating material in variety of ways quantity and sizes.

5. A portable light string according to claim 1, in which the handles are attached to the thin flexible insulating material via any suitable attaching technique.

6. A portable light string according to claim 5, in which the attaching technique is stitching.

7. A portable light string according to claim 1, further comprising a sealing means for ensuring tight engagement between the light bulbs and the electrical connection to the power source.

8. A portable light string according to claim 1, in which at least the outer surface of the thin flexible insulating material is made of a waterproof material.

9. A portable light string according to claim 1, in which the light bulbs are LED.

10. A portable light string according to claim 1, in which one or more light bulbs are Infra Red type.

11. A portable light string according to claim 1, in which the thin flexible insulating material is made of textile material.

12. A portable light string according to claim 1, in which the handles are configured in such a way that each handle can be physically interconnected with a handle of additional portable light string device.

13. A portable light string according to claim 1, in which the conductive string further comprising an electrical extension means for allowing to electrically connecting said portable light string to one or more additional portable light strings, thereby allowing to use a single power source to drive a plurality of interconnected portable light strings.

14. A portable light string according to claim 1, in which the thin flexible insulating material may have an elongated form or any other geometrical form that will allow the layout of the light bulbs along it.
